(19) United States
(12) Patent Application Publication
(10) Pub. No.: US 2007/0059476 A1
(43) Pub. Date: Mar. 15, 2007

(54) Contact clear decorative wall elements

(75) Inventor: Peter J. Dronzek JR., Thornwood, NY (US)

Correspondence Address: HEDMAN & COSTIGAN P.C., 1185 AVENUE OF THE AMERICAS, NEW YORK, NY, 10036, US

(73) Assignee: Polymeric Converting LLC

(21) Appl. No.: 11/520,359

(22) Filed: Sep. 13, 2006

Related U.S. Application Data
(60) Provisional application No. 60/716,792, filed on Sep. 13, 2005.

(51) Int. Cl. B32B 33/00

(52) U.S. Cl. 428/40.1

(57) ABSTRACT

A clear or contact clear decorative element based on polymeric film for the decoration of surfaces using wall borders, discrete appliques or wallpaper that allows for premium decoration through the transmission of the background of the decorated surface through the element. Unique computer generated on demand and preprinted images are used.

This application claims the priority of Provisional Application Ser. No. 60/716,792, filed Sep. 13, 2006.

### FIELD OF THE INVENTION

This invention relates to decorative wall elements in the form of borders, appliques or synthetic wall paper which are manufactured from clear or contact clear polymeric film that has a decorative image on at least one surface and a removable adhesive to affix the decorative element where the color of the underlying surface that the element is affixed to comes through the element to function as the background color providing for a decorative image that has the “no border look” where it appears to have been applied directly to the underlying layer since it does not have a background with a different color and the background color surrounds the indicia of the decorative image.

Kauss, et al., U.S. Pat. No. 5,196,246 describes an improved wall decorating system that utilizes a film comprising about 60-98% by weight ionomer resin that is a copolymer of ethylene and acrylic acid or methacrylic acid neutralized by a metal cation and about 2-40% by weight of a filler material. The filler material imparts conformability but will impact clarity so it can not be used as a clear or contact clear base of the present invention and in fact, the invention is directed to replacing white opaque plasticized vinyl for wall decoration as evidenced by the comparative examples. Kauss also details an adhesive comprising between about 60-100% by weight of hollow, polymeric, acrylate, inherently tacky, infusible, solvent-insoluble, solvent-dispersible, elastomeric pressure-sensitive adhesive microspheres which will impart significant haze due to diffraction of light through the high concentration of spheres and compromise the ability of the underlying color of the present invention to come through the adhesive coated film.

Martinez, et al., U.S. Pat. No. 4,900,604 details a vinyl film based wall decorating system with self-adherent, pre-cut decorative appliques that removably attach onto substrate sheets adhered to walls. Both the appliques and the substrate sheets are manufactured from vinyl and utilize a reusable, non-permanent adhesive coating. Such a coating permits rearrangement of the appliques on the substrate sheets and on top of each other and rearrangement of the substrate sheets on the walls, in a peel-off/press-on manner. Each applique provides decorative imagery of a common theme. Additionally, the substrate sheets may include decorative imagery which cooperates with the appliques to create a decorative wall scene. The appliques must inherently be manufactured from opaque material to prevent confusion of the printed imagery as they are applied on top of each other.

Weinberg, U.S. Pat. No. 5,885,396 discloses an apparatus and method for cutting wallpaper borders that economically cuts continuous patterns along the length of the wallpaper border where a microprocessor controls the spread of the wallpaper borders that passes through the laser cutting device and also operates the laser cutter so that the latter cuts a predetermined path along the length of the wallpaper so that many small perforations provide a score line which may be easily torn. According to the invention, a continuous score line is provided along the decorative pattern of a wallpaper border between a straight edge thereof and the decorative pattern. The straight edge is used to position the border relative to the line by aligning the straight edge against the corner between the wall and the ceiling. A pressure sensitive adhesive is applied to the side of the border opposite that upon which the decorative pattern is imprinted so that the border may be applied and removed from the wall. After the border has been applied to the wall, the non-decorative portion of the border between the design and the straight edge is removed by peeling this portion off the wall and tearing it along the score line formed by the laser cutter. Accordingly, the upper edge of the border is nonlinear, which is far more interesting than the straight edge former borders which were applied in engagement with the corner between the ceiling and the wall. If desired, another nonlinear score line may be made between the other straight edge opposite the one applied to the corner between wall and the ceiling. This score line is between the straight edge forming the lower edge of the border and the decorative pattern, so that the lower edge of the border is also nonlinear. Accordingly, the border may be quickly and easily applied in much the same manner that prior art borders have been applied. The strip between the straight edge and the pattern can then be quickly and easily removed, thereby leaving a nonlinear edge which enhances the decorative appeal of the border. The current invention using clear or contact clear films provides the same enhancement in decorative appeal by having the background color transmit through the film without having to precisely laser cut and remove pieces after application and is a further enhancement because the background can come through the indicia in the printed image which is not the case with the part of the border left behind in Weinberg.

The present state of the art shows that opaque wall borders can be adapted for enhanced graphic appeal along the edges of the border using the additional step of laser cutting during wall border manufacturing and the additional step of removing the unwanted edge material bordering the indicia after application to create a partial “no border look”. The current invention detailed herein eliminates the extra steps and creates a complete “no border look” where the background color transmits through around the decorative image.

This invention provides for an improved process for decorating using clear or contact clear wall borders, appliques or synthetic wall paper to enhance the graphic appeal of the decoration while smoothly blending the decoration into the background color of the surface to be decorated by having the background color transmit through the clear or contact clear film with decorative imagery.

It has also been found that the process for decorating with the “no border look” is simplified by using clear or contact clear films that can be easily handled, applied and removed versus the more conventional stencil painting and preprinted rub on transfers commonly used in the art today to achieve this look.

### BRIEF DESCRIPTION OF THE DRAWINGS

In the drawings:

FIG. 1 is a cross-section view of a clear or contact clear decorative wall element constructed in accordance with the present invention;

FIG. 2 illustrates another clear or contact clear decorative wall element that is digitally imaged with variable data in accordance with the present invention;

FIG. 3 illustrates a clear or contact clear decorative wall element that is conventionally printed with indicia that is buried between the adhesive and film and digitally printed on the surface.

### SUMMARY OF THE INVENTION

According to this invention, there is provided a clear or contact clear decorative wall element, comprising:
(i) a clear or contact clear film support layer having an upper surface and a lower surface;
(ii) a removable pressure sensitive adhesive layer secured to the lower surface of the decorative element which is used to affix the element to the surface to be decorated;
(iii) a removable throw away protective release liner made from film or paper secured to the adhesive to protect the adhesive from contamination until used;
(iv) optionally, a print enhancing or receiver layer;
(v) a decorative image applied to the surface of the clear or contact clear film support or optional print enhancing or receiver layer and/or optionally pre-print applied to the underside of the film support before adhesive coating;
(vi) optionally, a means for reducing the gloss of the clear film decorative wall element so it blends in with the gloss level of the surrounding wall by means of a surface coating or the use of a coextruded film with a matte exposed skin to receive indicia.

In preferred embodiments:
the clear or contact clear film support will be manufactured from polymers with <15% haze (test method ASTM D-1003) at the thickness to be used and will have dead fold characteristics for conformability around sharp corners. Most preferred as the clear film support is clear high density polyethylene with a haze level <5% that is oriented by conventional techniques in either the machine direction, transverse direction or both directions and
the film support will have a thickness between 0.5 to 7 mils thick, most preferably 1.5-4 mils thick; and
the throw away release liner will be release coated for easy removal of the liner and most preferably is manufactured from film with a smooth surface for the least amount of adhesive surface disruption which impacts optical clarity when laminated to the release liner and
the adhesive system is contact clear and removable from conventional painted plaster, wall board and wall paper.

A removable pressure sensitive adhesive is defined as an adhesive that will permit clean removability of the adhesive coated element without leaving adhesive residue behind when removed within a fixed period of time after application. It needs to be recognized that after extended periods of time such as multiple years, it is not uncommon even for removable adhesives to build such a bond that it will leave some residue after extended aging.

Preferably, the adhesive incorporates hollow clear acrylic spheres up to 45% by dry weight of the adhesive but most preferably in the range of 20-30% by dry weight of the adhesive for the optimum balance of clean removability and clarity.

In another of its major aspects, the present invention contemplates a clear or contact clear decorative wall element that is digitally imaged with variable colored indicia such as from an ink jet, laser, thermal transfer or other toner technology. A reduced gloss surface is incorporated through coextrusion of a fine matte skin to receive the decorative image or application a gloss control pre-print primer before printing or gloss control coating after the decorative image is applied is used for gloss control to control the level of gloss of the element to achieve the “no border look”. This level is variable based on the gloss level of the surface the decorative element is applied to but in general should not exceed a gloss level of 60, preferably less than 25 and more preferably less than 10 using a Gardner gloss meter with a 60 degree angle sensor measuring the sample applied to the decorated surface.

### DETAILED DESCRIPTION OF THE INVENTION

The decorative wall element can be used as an individual applique or piece for discreet decoration, a continuous border or a large sheet to replace wallpaper or as a protective system over wallcoverings such as paint or wallpaper. Specific mention is made of wallpaper where entire rooms can be covered with the decorative element where the properties of the film can be tailored to not only provide a means for decoration, but a means to impart fire protection and/or energy conservation

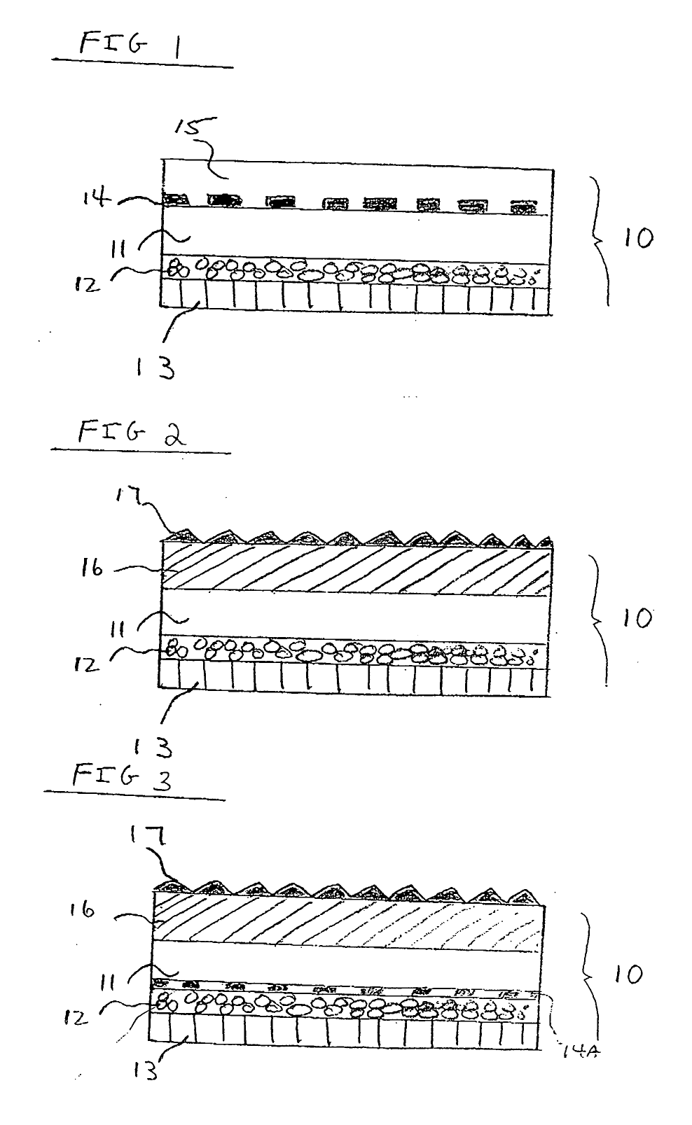

Referring to FIG. 1, the contact clear decorative wall element 10 is comprised of clear or contact clear film substrate 11, removable adhesive layer 12 on the underside of 11 to which protective release layer 13 is affixed, decorative image 14 is applied to the upper side of 11. optionally, gloss reduction coating 15 is applied over decorative image 14. Referring now to FIG. 2, this embodiment of the invention differs from the previous element of FIG. 1 with the addition of an imageable receiver layer 16 to receive variable image data in the form of computer generated output with image 17.

Referring now to FIG. 3, this embodiment of the invention is a combination of the elements in FIG. 1 and FIG. 2 where preprinted decorative image 14A is applied on the underside of the clear film between the adhesive and film and a computer generated image layer 16 with image 17 on the surface of the support.

Many different clear or contact clear polymeric films such as polyester, polypropylene, vinyl, polyethylene or combinations can be used to achieve the results of the invention. The haze of the film must be less than 15% and preferably less than 5% depending on the color of the background that the decorative element will be applied over. Preferably no filler that will impart haze is used in the clear or contact clear film element but up to 1.5% of the total weight of the film can be used in a coextruded surface layer to impart a fine matte anti-glare finish which would only be in the surface layer. The film substrate can be treated to enhance adhesion of adhesive and indicia by means conventional in the art such as by flame, corona and plasma treatment and will preferentially incorporate ultraviolet light blocking additives to prevent fading and yellowing of the film substrate, adhesive and decorated surface. Preferentially, mono or bi-axially oriented high density polyethylene is preferred for wall appliques or borders because it has excellent dead fold characteristics for wrapping around corners and does not contain migratory plasticizers. Transverse direction (mono) oriented HDPE film is available from ExxonMobil Films, Macedon, N.Y. and Southline, New Castle, Del.

Additionally, for applications where large sheets of the decorative element will be used like wallpaper and cover the majority of walls, it is contemplated that specific properties can be built into the clear or contact clear film base of the element that can add other functional properties such as flame retardant if a flame retardant film such as Tedlar® available from DuPont, Wilmington, Del. is used. In instances where a film of this type would be used such as in a childs bedroom, increased flame retardant would be provided for added protection during a fire.

Many polymeric films such as extruded Saran®, PVDC coated films from ExxonMobil Chemical Company, Macedon, N.Y. provide excellent moisture vapor properties and will be useful in controlling the humidity in an environment lined with the element. For example, in hot humid environments, if a saran coated HDPE film is used, air conditioning systems would not need to work as hard to remove ambient moisture penetrating the room from the outside air and would require less energy to maintain the system at equilibrium. Full coverage of the decorative intermediate can be multifunctional where in addition to decorative, it can be an energy saving installation. Further on energy savings, typical painted walls and wall paper readily allows for heat transfer (gain or loss) to the environment depending on the season. The decorative element being solid polymer based will act as a better insulator than porous walls and the insulation properties will be enhanced when combined with hollow spheres incorporated into the adhesive that act as a sealed air gap providing insulative properties so this is another aspect where the element can have dual functionality being decoration and energy savings.

As used herein, the term “removable adhesive” means a pressure sensitive adhesive that adheres a film structure to a surface in such a manner that even after an extended period of time i.e. 6 months to 2 years, will allow complete removal of the film structure without substantially damaging the film structure and without leaving any substantial residue of the removable adhesive on the surface. A wide range of adhesives can be formulated to function as a removable adhesive but adhesives based on acrylic resin that is UV resistant are preferred. For best removability, it is preferred to incorporate fine hollow acrylic spheres that reduce the surface contact of the adhesive and promote clean removability. Optimally, a range of 20-30% of spheres by dry weight of adhesive is preferred but they can be incorporated up to 45% dry weight depending on the type of surface to be labeled. For best optics and see through clarity, the spheres should have a particle size distribution of 10-50 microns, preferably 20-40 microns with an average particle size of 25-30 microns. Adhesives of this type are available from Franklin International, Columbus, Ohio and are known as Micronax adhesives. Generally, a coating weight which is effective to hold the decorative wall element to a surface will be used. This coating will be about 6-18 grams/square meter (gsm), preferably 9-12 gsm).

Any conventional release liner can be used as is known in the art and the release level should be matched with the adhesive formulation to allow easy separation during application but not premature delamination in handling. A conventional release liner is typically based on a film or paper substrate that is coated with a solution of a release substance that is subsequently dried and/or cured leaving a low energy surface that releases well from pressure sensitive adhesives. These types of release liners and are available from Siltech, Miamisburg, Ohio. Low surface energy extruded or coextruded films with inherent release characteristics can also be used such as Teflon film available from Dupont, Wilmington, Del.

The decorative image can be applied by conventional printing techniques such as gravure printing known in the art now predominantly used for production of wall borders and wall paper on opaque substrates. Other conventional printing techniques such as flexographic and lithographic can also be used. In all these cases, the image whether a continuous, repetitive or random pattern for wallpaper or wall border or a specific image for a decorative applique will be pre-printed with a design. In applications where the decorative image is applied by conventional means, the adhesive can be applied before printing, after printing or in-line with printing. Print enhancing coatings function as a primer layer applied to the clear or contact clear substrate prior to printing to improve ink adhesion and wet out and are available for Adhesion Systems, Paterson, N.J. such as LM659-24 a modified acrylic resin at 40% solids in water carrier.

Optionally, the decorative element can be made into a receiver element through the use of surface coatings to allow reception of unique on demand color digital images through the use of ink jet, laser, thermal transfer and other color based digital imaging techniques where the images can be customized by the consumer using a home computer and can incorporate digital photographs and computer generated artwork all using a clear element that allows the background of the surface to be decorated to come through producing a premium decorative element. It is contemplated that clear or contact clear blank element can be imaged at kiosks set up in the home decorating area of stores based on the images brought in by consumers to customize their wall border, wall paper or large decorative applique. Smaller cut sheet appliques can be imaged at home on a color printer. Print receiver coatings known in the art are available to receiver computer generated output and are available as from Michelman Inc, Cincinnati, Ohio known as MP4990 a 32% Ethyl Acrylic Acid dispersion in water for laser toner applications or urethane based ink jet receiver coatings available from Dainippon Ink And Chemical, Japan.

Gloss control is an important aspect of the “no border look” because there are different types of paint finishes used to coat the surface to be decorated that vary in gloss level such as flat, egg shell, satin, semi-gloss, gloss and enamel to name a few. Elements that are preprinted will in many cases employ an overprint coating or varnish for gloss control so a shiny border is not applied to a flat wall. Gloss control coatings or co-extruded layers typically employ the addition of small inorganic particles such as silica, calcium carbonate or china clay to name a few that break up the surface reflection due to the matte texture imparted by the matte particles. Examples of particles that can be used are ASP200 clay available from Engelhard Corp., Edison N.J. or Syloid 244 silica available from W. R. Grace. Another option is to make the print surface multi-functional as a gloss control surface through the use of a pre-coat or coextruded layer to reduce gloss and enhance adhesion.

Many variations of the present invention will suggest themselves to those skilled in the art in light of the above detailed description. All such obvious modifications are within the full intended scope of the appended claims.

1. A clear or contact clear decorative wall element, comprising:
(i) a clear or contact clear film support layer having an upper surface and a lower surface;
(ii) a removable pressure sensitive adhesive layer secured to the lower surface of the decorative element which is used to affix the element to the surface to be decorated;
(iii) a removable throw away protective release liner made from film or paper secured to the adhesive to protect the adhesive from contamination until used;
(iv) optionally, a print enhancing or receiver layer;
(v) a decorative image applied to the surface of the clear or contact clear film support or optional print enhancing or receiver layer and/or optionally pre-print applied to the underside of the film support before adhesive coating;
(vi) optionally, a means for reducing the gloss of the clear film decorative wall element so it blends in with the gloss level of the surrounding wall by means of a surface coating or the use of a coextruded film with a matte exposed skin to receive indicia.

2. A clear or contact clear decorative wall element having a print receiving layer.

3. A clear or contact clear decorative wall element as defined in claim 1 wherein the film support layer is a laminate of two or more polymeric films that are joined together by an adhesive.

4. A clear or contact clear decorative wall element as defined in claim 1 wherein the print support layer has a print enhancing or receiving layer.

5. A clear or contact clear decorative wall element as defined in claim 1 which includes means for reducing the gloss of the clear film decorative wall element so it blends in with the gloss level of the surrounding wall by means of a surface coating or the use of a co-extruded film with a matte exposed skin to receive indicia.

6. A clear or contact clear decorative wall element as defined in claim 1 wherein the clear or contact clear film is a high density polyethylene having a maximum haze level of 15% as measured according to ASTM D-1003.

7. A clear or contact clear decorative wall element as defined in claim 6 wherein the high density polyethylene is an oriented polyethylene.

8. A clear or contact clear decorative wall element as defined in claim 1 in which the removable adhesive is an acrylic pressure sensitive adhesive contains hollow acrylic spheres.
